(19) United States
(12) Patent Application Publication
(10) Pub. No.: US 2017/0043255 A1
(43) Pub. Date: Feb. 16, 2017

(54) Interaction between Virtual Reality Entities and Real Entities

(71) Applicant: NOKIA TECHNOLOGIES OY, Espoo (FI)

(72) Inventor: Teemu Savolainen, Tampere (FI)

(21) Appl. No.: 15/305,710

(22) PCT Filed: Apr. 25, 2014
(86) PCT No.: PCT/US2014/035477

§ 371 Date: Oct. 21, 2016

(51) Int. Cl. A63F 13/65; A63F 13/335; H04L 29/06; H04W 4/00; H04L 29/08

(52) U.S. Cl. CPC A63F 13/65; H04W 4/008; H04L 67/02; H04L 67/10; H04L 67/38; A63F 13/335; A63F 2300/8082

(57) ABSTRACT

Methods and apparatus, including computer program products, are provided for accessing virtual devices. In one aspect there is provided a method. The method may include scanning, by a user equipment, for one or more virtual devices that are published; and accessing, by the user equipment, a state of the scanned one or more virtual devices. Related apparatus, systems, methods, and articles are also described.

### FIELD

The subject matter described herein relates to virtual reality and/or the Internet of Things.

### BACKGROUND

Virtual reality generally refers to providing a user with a first person point of view in a game including for example a simulation. For example, a multi-user video game may allow a virtual reality user to play the video game as if the user is in the game. Virtual reality games may vary in the level of game immersion from simple role-play to more complex three-dimensional (3D) representations in which the user wears 3D eyewear to become fully immersed in a game role, although virtual realities may be generated that have fewer than three-dimensions as well. Moreover, some of the virtual reality games can continue in the Internet or cloud of servers even after a player exits a game, so that when a player re-enters, the virtual reality game has progressed temporally.

### SUMMARY

Methods and apparatus, including computer program products, are provided for virtual reality and/or the Internet of Things.

In some example embodiments, there may be provided a method. The method may include scanning, by a user equipment, for one or more virtual devices that are published; and accessing, by the user equipment, a state of the scanned one or more virtual devices.

In some variations, one or more of the features disclosed herein including the following features can optionally be included in any feasible combination. The one or more virtual devices may include one or more internet of things devices. The one or more virtual devices may be published by advertising a identifier for each of the one or more virtual devices. The identifier may include at least one of an indication that a virtual device is virtual, an identity of a game where the virtual device is located, or an identity of a user associated with the game. The resource identifier for a virtual device may include a same format as another identifier for a real device. The user equipment may present a user interface including one or more icons corresponding to the scanned one or more virtual devices and one or more other icons corresponding to one or more real internet of things devices. The one or more virtual devices may be published by a gaming device.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

In the drawings,

FIG. 1 depict an example of a system for coupling the real and virtual worlds, in accordance with some exemplary embodiments;

FIG. 2 depict an example of a process for exposing a virtual node to the real world, in accordance with some exemplary embodiments;

FIG. 3 depict an example of a process for adding a real node to a virtual reality, in accordance with some exemplary embodiments;

FIG. 4 depict an example of a process for adding a virtual nodes to a real world device, in accordance with some exemplary embodiments;

FIGS. 5A-5G depict examples of adding virtual devices to real world devices and vice versa, in accordance with some exemplary embodiments; and

FIG. 6 depicts an example of a user equipment, in accordance with some exemplary embodiments.

Like labels are used to refer to same or similar items in the drawings.

### DETAILED DESCRIPTION

The Internet of Things (IoT) generally refers to Internet connected nodes including simple sensors and other smart objects, examples of which temperature sensors, moisture sensors, monitors, light actuators, security devices, heaters, coolers, household appliances, and any other device. These IoT nodes may be found in the real world as well as in the world of virtual reality. However, the real IoT nodes and virtual IoT nodes may not communicate. The subject matter disclosed herein may thus provide ways of enabling communications, interactions, and/or interoperations between virtual reality and the real world.

In some example embodiments, one or more virtual IoT nodes, such as virtual devices, virtual sensors, virtual actuators, virtual control units, and the like, in a virtual reality system may be made available via IoT-type protocols and thus made visible for selection in a manner similar to other real IoT nodes/devices.

In some example embodiments, there may be provided ways for allowing interaction between virtual IoT nodes and real IoT nodes, without those nodes necessarily knowing whether the peer nodes are real or virtual.

In some example embodiments, a virtual reality game implementing virtual IoT nodes may use an application-programming interface (API) provided by for example a virtual reality gaming device to register virtual IoT nodes with the virtual reality gaming device's operating system. This API may thus expose the virtual IoT nodes and, as such, make the virtual IoT nodes accessible and visible to the real world including the Internet and/or local area networks. This may thus allow real world IoT nodes to subscribe, follow, and/or control the state of the virtual IoT nodes. Moreover, any state change a game may make to a virtual IoT node may be reflected to the real world via the gaming device and/or the API therein.

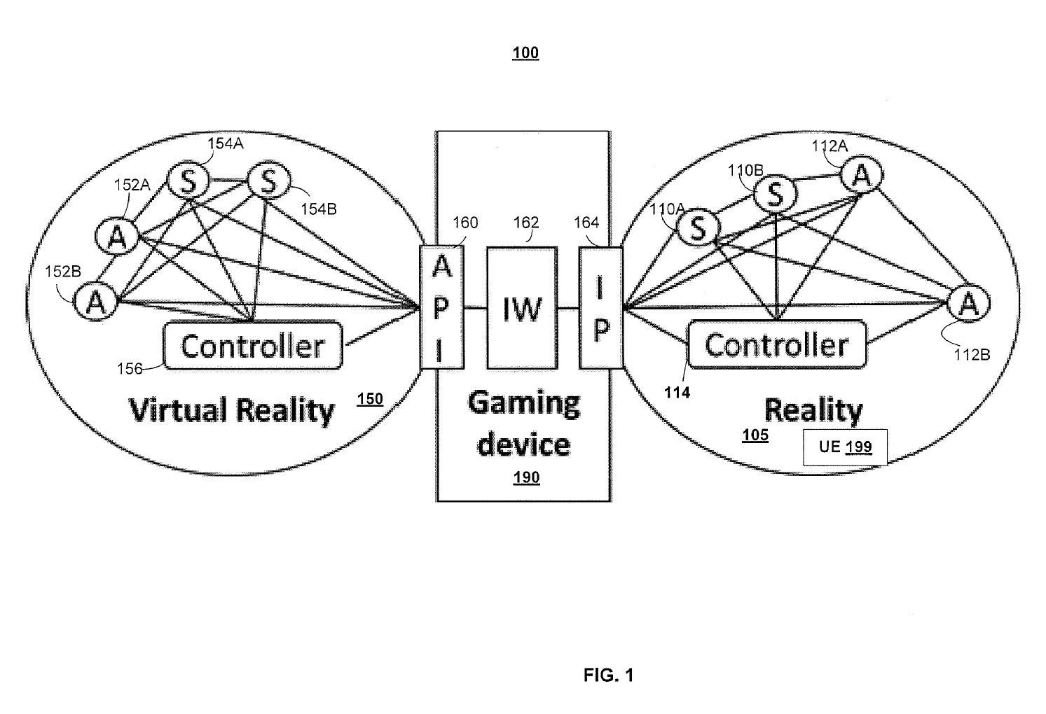

FIG. 1 depicts an example of a system 100, in accordance with some example embodiments. The system 100 may include a virtual reality 150 portion, which may be implemented as a game running in a gaming device 190 and/or as a game running in a cloud server (to which gaming device 190 can connect to over a network, such as the Internet, a local area network, and/or any other network). The game being executed may include one or more software modules that implement the roles of virtual IoT nodes, such as virtual actuators 152A-B (labeled “A”), one or more virtual sensors 154A-B, (labeled “S”), a virtual controller 156 for the virtual devices, and/or any other virtual devices. The controller 156 may also access and control real life devices, such as real IoT nodes. The one or more software modules may communicate directly with each other inside virtual reality 150. Moreover, the one or more software modules may register via API 160 with for example the gaming device 190, and this registration may allow the software modules that implement the virtual IoT nodes to communicate with real world 105.

The reality portion 105 may include one or more real-world IoT nodes, such as real sensors 110A-B, actuators 112A-B, and a controller 114. Moreover, the real IoT nodes may communicate with each other in a variety of ways including for example, using one or more protocols, such as Constrained Application Protocol (CoAP), MQ Telemetry Transport, AllJoyn, Internet Protocol (IP), and/or any other protocol(s) to facilitate communication among or between the IoT devices and/or with gaming device 190 as well.

In some example embodiments, gaming device 190 may include an IP 164 and an lnterworking Function 162 (labeled “IW”) that implement necessary translations and transactions between the virtual reality API 160 and the technology of the real world portion 105.

In some example embodiments, gaming device 190 may include at least one processor circuitry and at least one memory including computer code which when executed by the at least one processor circuitry provides at least the operations disclosed herein with respect to the gaming device. The gaming device may implemented as a dedicated gaming player (for example, an Xbox as well as any other gaming device or player), a personal computer, a smart phone, a phone, a tablet, a television, a cloud server, and/or any other process-based device or devices including those devices used for non-gaming activities.

In some example embodiments, virtual IoT nodes, such as nodes/device 152A-B, 154A-B, and/or 156, may be represented in the real world as unique resources. For example, the gaming device 190 may make the unique resources of the virtual reality 150 available outside of gaming device 190 by using standard protocols, such as CoAP and the like. This may allow one or more real-world devices to discover the virtual nodes in a variety of ways (for example, via a node or network discovery protocol, such as CoAP, Universal Plug and Play (UPnP), Zeroconf, Bonjour, Multicast DNS (MDNS), Link Local Multicast Name Resolution (LLMNR), AllJoyn, Data Distribution Service (DDS), Message Queuing Telemetry Transport (MQTT), Advanced Messaging Queuing Protocol (AMQP), Java Message Service (JMS), and/or the like. Moreover, gaming device 190 may also discover real world nodes, such as devices/nodes 110A-B, 112A-B, and/or 114, and make them available for the virtual reality game at gaming device 190.

The virtual IoT nodes 152A-B, 154A-B, and/or 156 may be identified using a naming convention in a variety of ways including using an identifier, such as a unique resource identifier as well as other types of identifiers as well. The identifier may indicate that IoT node is virtual, indicate an identity of a game in which the virtual IoT node is located, and/or indicate an identity of a player associated with the game in which the virtual IoT node is located. For example, a virtual reality movement sensor 154A in virtual reality may have a Unique Resource Identifier as well as any other type of naming convention, such as MQTT topic or AllJoyn reverse naming convention. In the case of CoAp, the identifier may be, for example, in CoAP “coap://example.com/virtual/grandcitygame/playerid123 5/movement.” In the case of MQTT, the identifier may be, for example, “virtual/grandcitygame/playerid1235/movement.” And, in AllJoyn the identifier may be as follows: “com.example.virtual.grandcitygame.player1235.movement,” although other formats may be used as well. Moreover, the gaming device 190 may expose this unique resource identity/naming convention of the virtual IoT to the real world 105 via the API 160 to allow discovery and use in the real world.

Alternatively or additionally, the gaming device may use other resource identification conventions as well. For example, gaming device 190 may expose the virtual reality gaming resource, such as a virtual reality temperature sensor 154B, by identifying sensor 154B as “/sen/temp” (which may hide its virtual nature but may enable interoperability among IoT devices). Moreover, this resource identifier may be performed in accordance with a standard, such as the Internet Protocol of Smart Objects (IPSO) Alliance (http://www.ipso-alliance.org/wp-content/media/draft-ipso-app-framework-04.pdf) as well as other standards and/or proprietary techniques.

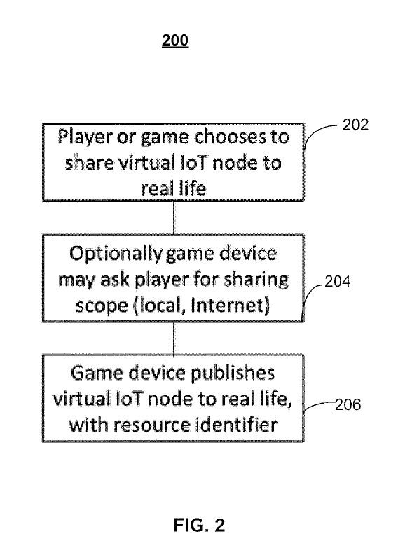

FIG. 2 depicts an example process 200 for exposing virtual IoT nodes to the real world, in accordance with some example embodiments. The description of FIG. 2 also refers to FIG. 1.

At 202, a selection may be received indicating that a virtual device may be exposed to the real world, in accordance with some example embodiments. For example, the gaming device 190 may choose to expose (for example, based on a user indication of a selection and/or a default preference) one or more virtual IoT nodes, such as nodes 152A-B, 154A-B, and/or 156, to the real world. This exposure may publish the resource identifiers for the selected one more virtual IoT nodes to allow other real world processor-based devices, such as user equipment 199 and/or any other device/node, to discover the exposed IoT node(s), access information from the exposed IoT node(s)/device(s), and/or influence the behavior of the exposed IoT node(s).

At 204, an indication may be received indicating the scope of the exposure, in accordance with some example embodiments. For example, the gaming device may prompt a user to indicate whether the virtual IoT nodes selected for exposure at 202 should be exposed to the entire Internet, a specific network (for example, a local area network or intranet), a specific community of users, and/or the like. Alternatively or additionally, the gaming device 190 may determine the scope based on a default preference.

At 206, the gaming device may expose the selected virtual device, in accordance with some example embodiments. For example, gaming device 190 may access the selected virtual device that have registered via API 160. Next, the IW 162 may generate a resource identifier for the selected virtual device, and then publish the selected virtual device resources in accordance with a protocol, such as via IP 164 as well as other protocols, to the real world. For example, the gaming device 190 may publish sensor 154B as “/sen/temp” to allow access by other devices in the real world 105, and the publication may have a scope in accordance with 204. The publishing may happen, for example, by gaming device adding one or more sensors to the CoAP well-known URI (/.well-known/core) listing/registry, sending an UPnP advertisement, advertising a name via an AllJoyn bus, registering as published in MQTT, and/or in any other way as well. Other devices may discover the IoT node/sensor by accessing the CoAP well-known URI, by receiving the UPnP advertisement message, by noting the new advertised name appearing in the AllJoyn bus, by noting a new published in MQTT, or the like.

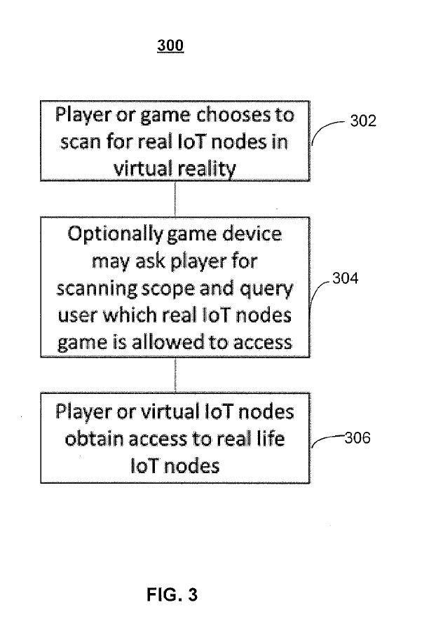

FIG. 3 depicts an example process 300 for a virtual game to add real IoT nodes to the virtual world, in accordance with some example embodiments. The description of FIG. 3 also refers to FIG. 1.

At 302, gaming device 190 may initiate a scan for real-world IoT nodes, in accordance with some example embodiments. For example, gaming device 190 may scan for one or more real IoT nodes by sending out multicast discovery messages, such as requests for CoAP well-known URI, sending UPnP service discovery messages, issuing AllJoyn find-name requests, using MQTT to subscribe to publisher(s), accessing directories such as CoAP Resource Directory, or the like. The gaming device 190 may also have cached unsolicited advertisements it has received earlier (for example with UPnP), and, as such, the gaming device 190 may use them as scan results. The scan may be based on a user indication and/or a default preference. The scanning may thus identity one or more real-world IoT nodes, such as nodes 110A-B, 112A-B, and/or 114 and the like.

At 304, gaming device 190 may allow selection of a scanning scope and/or query a user regarding specific real world IoT nodes that can be accessed by the virtual reality gaming device 190, in accordance with some example embodiments. For example, gaming device 190 may select (for example, based on a user input or a default preference) a scope of the scanning, such as the entire Internet, a local area network, a domain, a group of users, and/or the like to limit the scanning for real IoT nodes. Moreover, gaming device 190 may select (for example, based on a user input or a default preference) which real-world IoT nodes may be accessed in the virtual reality 150 of gaming device 190. In some example embodiments, limiting the scope may avoid accessing inappropriate IoT nodes (for example, nodes that may cause a loss of privacy, a security threat, and/or loss of money).

At 306, the virtual reality 150 at gaming device 190 may have access to the real IoT nodes, in accordance with some example embodiments. For example, controller 156 may access real life IoT nodes and thus read the state of the real IoT nodes and/or influence the behavior of the real life IoT nodes. As such, the virtual reality includes a real world IoT node/device.

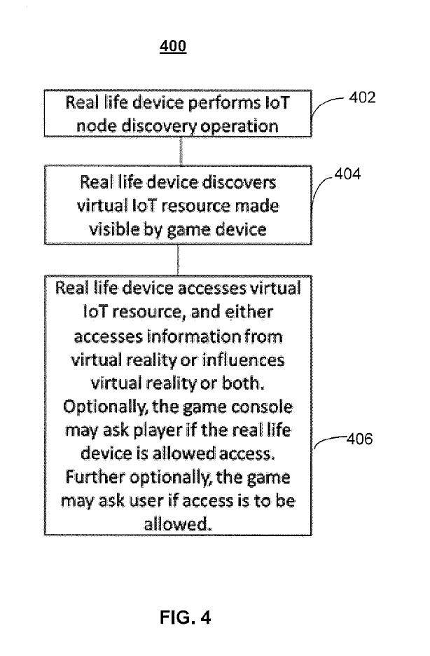

FIG. 4 depicts an example process 400 for a real world device to add virtual IoT nodes, in accordance with some example embodiments. The description of FIG. 4 also refers to FIG. 1.

At 402, a processor-based device 199 may perform IoT node discovery, in accordance with some example embodiments. For example, a real-world device, such as a computer, a smart phone, a real-IoT node, and/or any other or user equipment 199, may perform IoT node discovery by sending out multicast discovery messages, such as requests for CoAP well-known URI, sending UPnP service discovery messages, issuing AllJoyn find-name requests, using MQTT to subscribe to publisher(s), accessing directories such as CoAP Resource Directory, or the like. The processor-based device 199 may also have cached unsolicited advertisements received earlier (for example, with UPnP), and, as such, processor-based device 199 can use them similarly as scan results.

At 404, processor-based device 199 may discover one or more virtual IoT resources published by the gaming device 190, in accordance with some example embodiments. For example, gaming device 190 may publish resource information indicating one or more of the identities of the virtual IoT nodes, such as nodes 152A-B, 154A-B, and/or 156.

At 406, the processor-based device 199 may access virtual IoT node resources, in accordance with some example embodiments. The accessed information may be obtained directly from gaming device 190, and/or the processor-based device 199 may influence the behavior of the virtual reality IoT nodes. The gaming device 190 may also prompt or request a user whether the processor-based device 199 is allowed access to the virtual IoT node resources. When granted, the processor-based device 199 may access a virtual IoT node to for example read virtual IoT node state information and/or influence the virtual IoT node behavior (for example, change an actuator or take any other action in virtual reality).

In some example embodiments, a player may place for example a movement sensor in a virtual building in a virtual world running on gaming device 190, although the gaming device 190 may also be used to access a game running on a server as well. When this movement detector detects movement (for example, when another player enters the virtual building), a notification may be sent outside of the gaming device's virtual world to one or more real devices. The virtual IoT node's notification may include a real sound, a message being sent (for example, an SMS message, email, and/or any other type of message), and/or a visual indication (for example, lights blinking). Moreover, the virtual IoT node's notification received at the real device may be handled by the real device, as would any other IoT notification received from real IoT nodes. If a user has a real controller device (for example, at a smart phone and/or any other processor) for controlling IoT nodes, the same device may be used to monitor both real life IoT nodes and virtual IoT nodes. Although this example describes the virtual IoT as a motion sensor, other types of IoT devices may be used as well.

To illustrate further, a real world cooling fan (or heater) may be bound to a temperature sensor placed in a virtual world (such as, a sensor worn by a player's virtual avatar). The heater, or cooler, may be commanded to attempt replication of the temperature sensed by virtual sensor. This may allow the player to feel actual temperature changes (for example, cooling or heating) based on the game situation, and again, without heater or cooler knowing it is being commanded by virtual sensor. This real to virtual world binding may enhance the gaming experience for a user.

Likewise, a player, for example wearing 3D glasses, may have a virtual control device. This virtual control device may be commanded to follow the state of real world sensors, and, for example, when doorbell rings, the doorbell may send a notification to a virtual control device via a gaming device. Hence, the player of the gaming device may get real world alarms to the game, without real world sensor being aware of that.

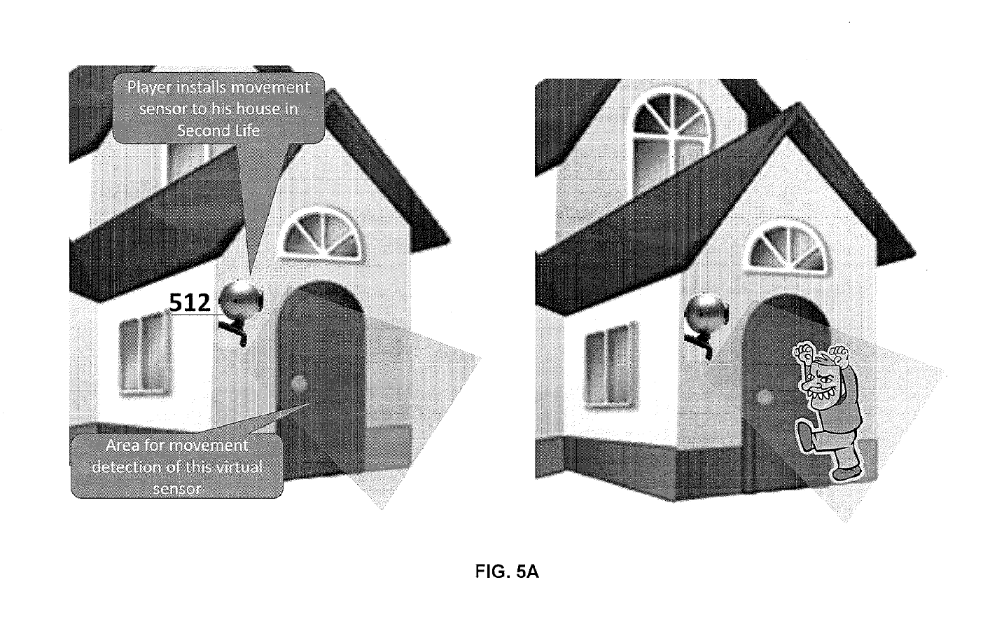

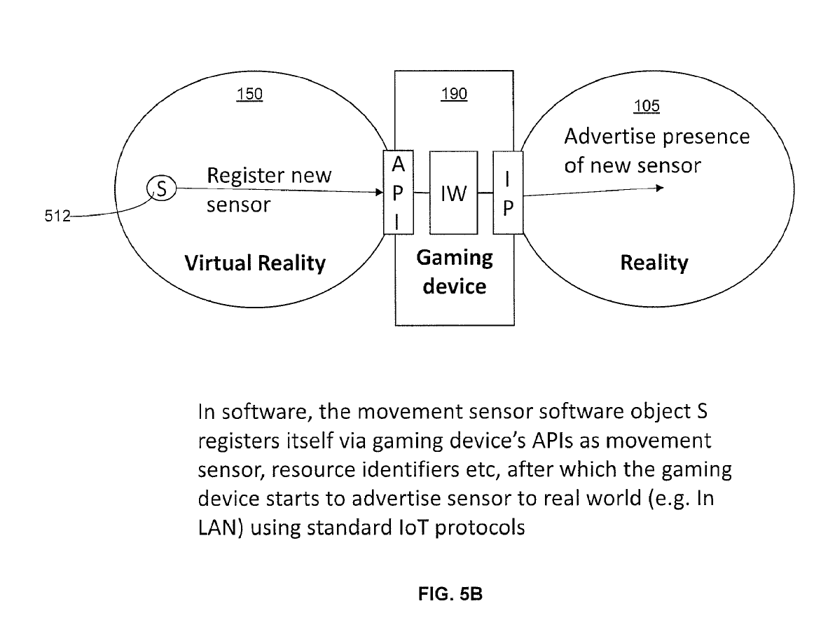

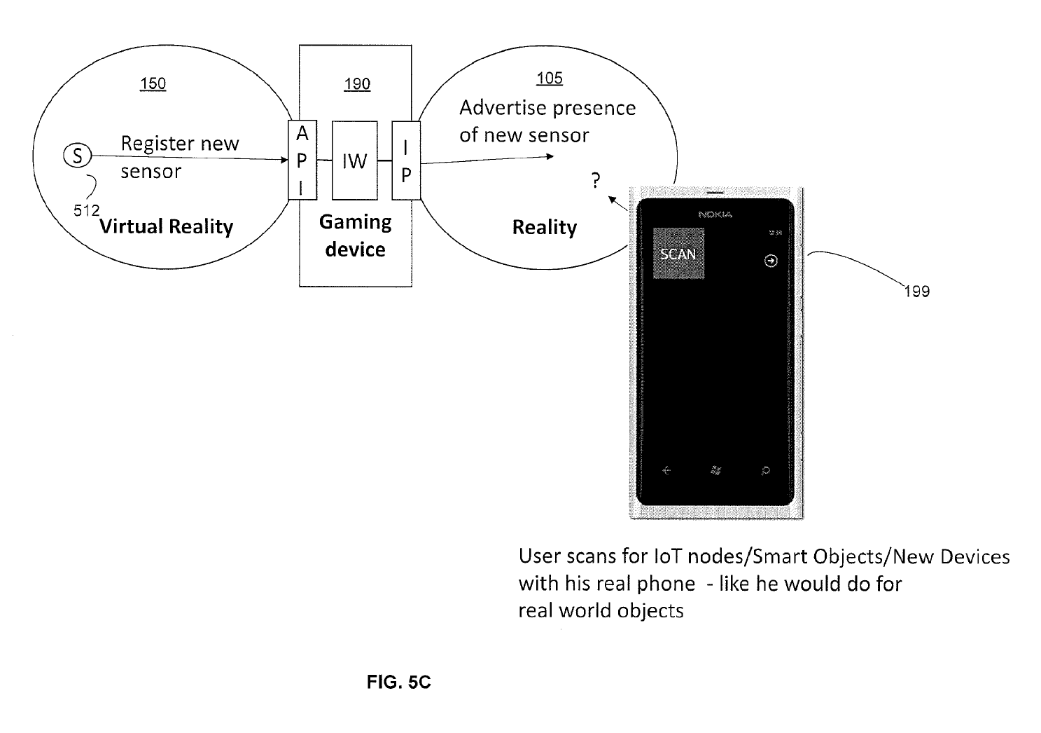

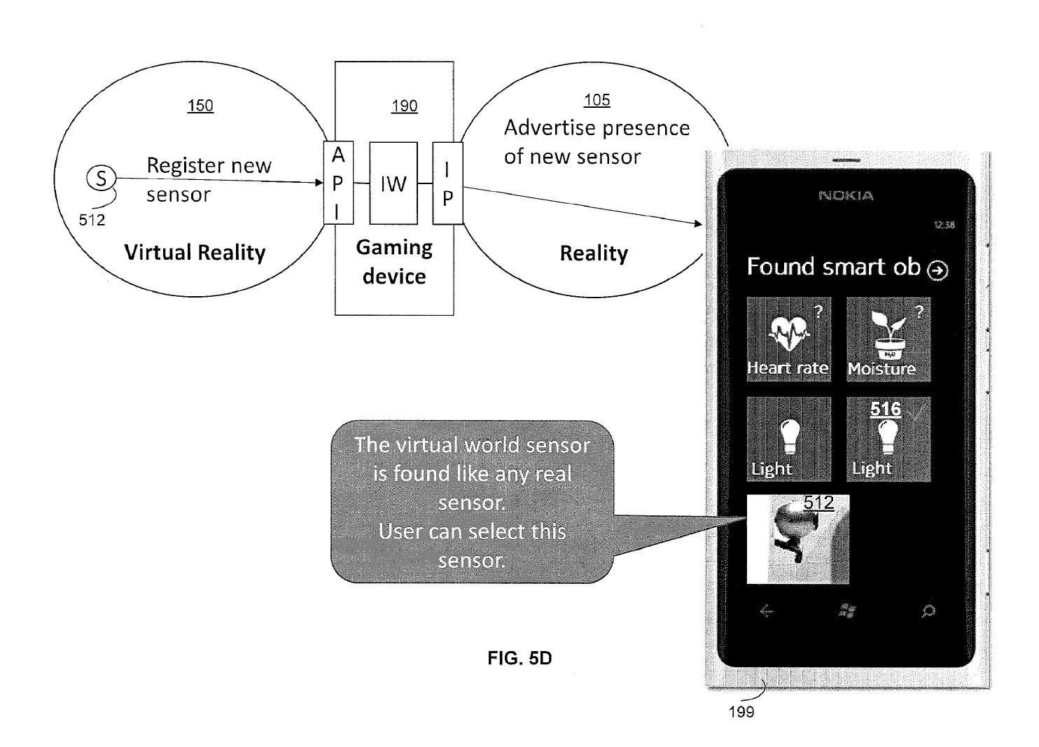

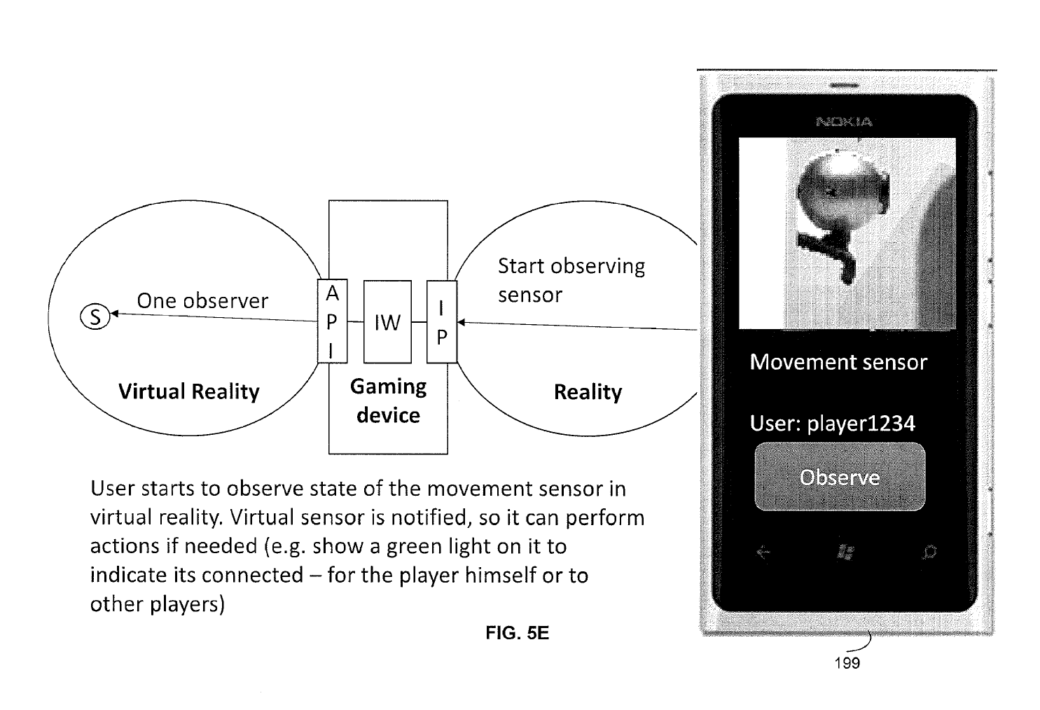

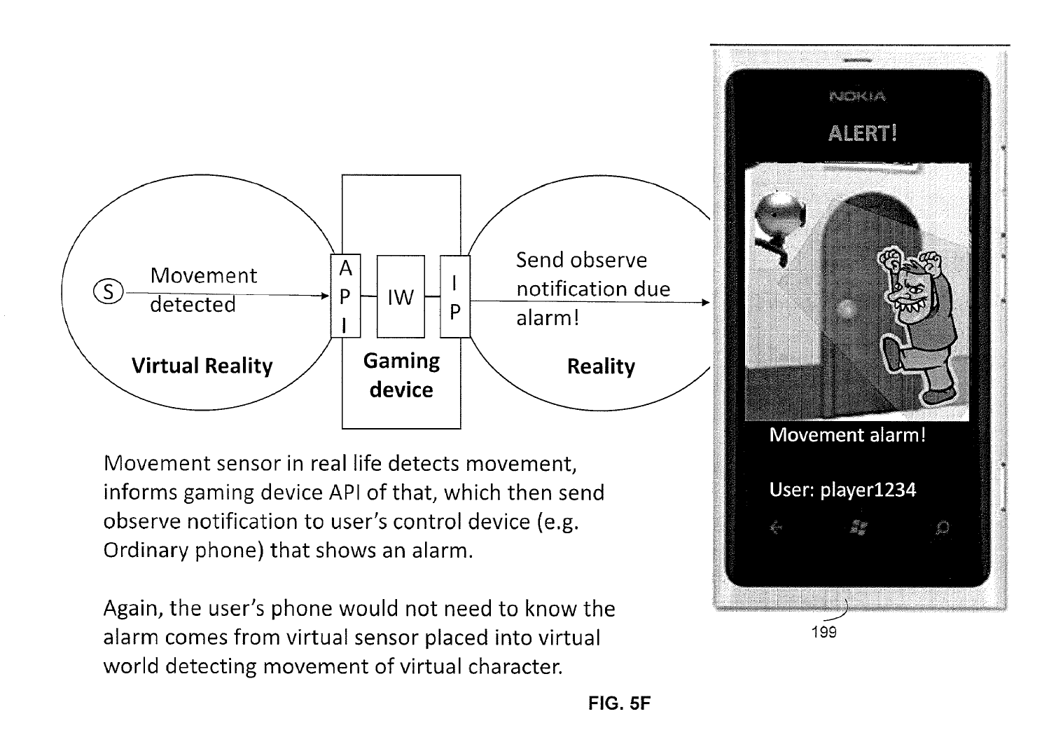

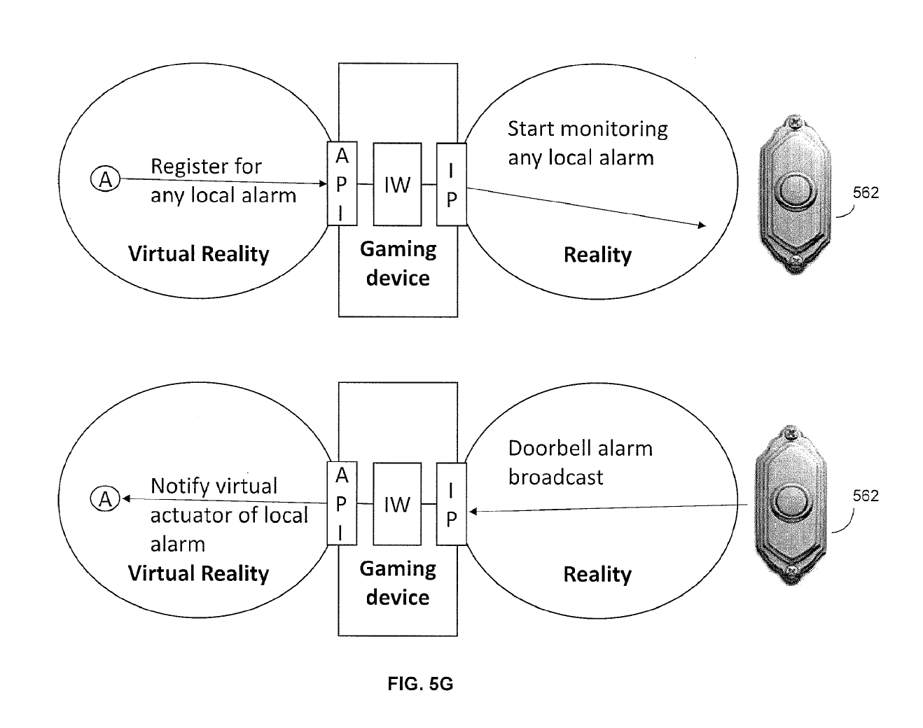

FIG. 5A-5G depict examples of the virtual and real-world IoT devices in use, in accordance with some example embodiments.

FIG. 5A depicts a virtual reality presented at a user interface by gaming device 190, in accordance with some example embodiments. In the example of FIG. 5A, a virtual motion sensor IoT device 512 is added to the virtual reality, and this motion sensor IoT device 512 may be selected for sharing to the real world in accordance with process 200. FIG. 5B depicts the gaming device 190 registering the added virtual sensor 512 and publishing added virtual sensor 512 to the real world 105. At FIG. 5C, a real world processor-based device 199 may scan for IoT nodes including virtual IoT nodes to discover among other things virtual sensor 512, in accordance with some example embodiments. This scanning may be performed in accordance with 400. At FIG. 5D, real world processor-based device 199 may add virtual sensor 512 to the IoT nodes being monitored and/or influenced by processor-based device 199. In the example shown, processor-based device 199 may monitor and/or influence the added virtual sensor 512 as shown by the icon along with other real IoT devices, such as IOT sensor light 516 and the like. At FIG. 5E, real world processor-based device 199 may observe virtual sensor 512 located in virtual reality. FIG. 5F shows real world processor-based device 199 receiving an alert from virtual sensor 512. FIG. 5G shows a real-world IoT device 562 being added (for example, in accordance with process 300) to gaming device 190 for monitoring. In this example, real world IoT device 562 represents a door alarm, which when activated sends an alarm to gaming device 190. In another embodiment, the real world IoT sensor alarm 562 may be activated in the virtual reality of gaming device 190 and shown to user, for example, on virtual wristwatch, virtual PDA, virtual heads-up display, other virtually wearable gadget, or other type of virtual device having a user interface.

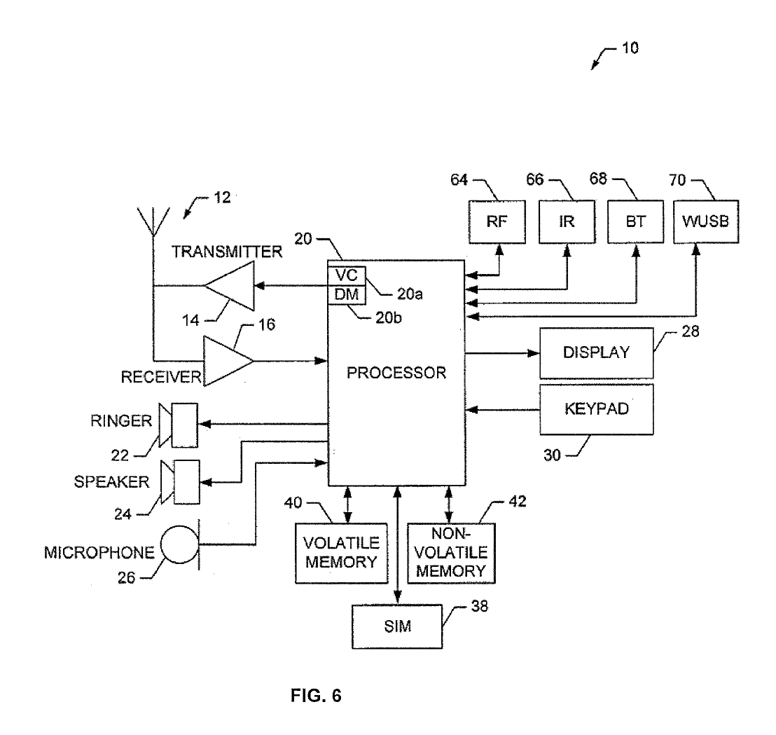

FIG. 6 illustrates a block diagram of an apparatus 10, in accordance with some example embodiments. The apparatus 10 (or portions thereof) may be configured to provide a real IoT node, a user equipment, a machine type communication device, a wireless device, a wearable device, a smartphone, a cellular phone, a wireless sensor/device, a gaming device, and/or any other processor-based device.

The apparatus 10 may include at least one antenna 12 in communication with a transmitter 14 and a receiver 16. Alternatively transmit and receive antennas may be separate. The apparatus 10 may also include a processor 20 configured to provide signals to and receive signals from the transmitter and receiver, respectively, and to control the functioning of the apparatus. Processor 20 may be configured to control the functioning of the transmitter and receiver by effecting control signaling via electrical leads to the transmitter and receiver. Likewise, processor 20 may be configured to control other elements of apparatus 10 by effecting control signaling via electrical leads connecting processor 20 to the other elements, such as a display or a memory. The processor 20 may, for example, be embodied in a variety of ways including circuitry, at least one processing core, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits (for example, an application specific integrated circuit (ASIC), a field programmable gate array (FPGA), and/or the like), or some combination thereof. Accordingly, although illustrated in FIG. 6 as a single processor, in some example embodiments the processor 20 may comprise a plurality of processors or processing cores.

Signals sent and received by the processor 20 may include signaling information in accordance with an air interface standard of an applicable cellular system, and/or any number of different wireline or wireless networking techniques, comprising but not limited to Wi-Fi, wireless local access network (WLAN) techniques, such as Institute of Electrical and Electronics Engineers (IEEE) 802.11, 802.16, and/or the like. In addition, these signals may include speech data, user generated data, user requested data, and/or the like.

The apparatus 10 may be capable of operating with one or more air interface standards, communication protocols, modulation types, access types, and/or the like. For example, the apparatus 10 and/or a cellular modem therein may be capable of operating in accordance with various first generation (1G) communication protocols, second generation (2G or 2.5G) communication protocols, third-generation (3G) communication protocols, fourth-generation (4G) communication protocols, Internet Protocol Multimedia Subsystem (IMS) communication protocols (for example, session initiation protocol (SIP) and/or the like. For example, the apparatus 10 may be capable of operating in accordance with 2G wireless communication protocols IS-136, Time Division Multiple Access TDMA, Global System for Mobile communications, GSM, IS-95, Code Division Multiple Access, CDMA, and/or the like. In addition, for example, the apparatus 10 may be capable of operating in accordance with 2.5G wireless communication protocols General Packet Radio Service (GPRS), Enhanced Data GSM Environment (EDGE), and/or the like. Further, for example, the apparatus 10 may be capable of operating in accordance with 3G wireless communication protocols, such as Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The apparatus 10 may be additionally capable of operating in accordance with 3.9G wireless communication protocols, such as Long Term Evolution (LTE), Evolved Universal Terrestrial Radio Access Network (E-UTRAN), and/or the like. Additionally, for example, the apparatus 10 may be capable of operating in accordance with 4G wireless communication protocols, such as LTE Advanced and/or the like as well as similar wireless communication protocols that may be subsequently developed.

It is understood that the processor 20 may include circuitry for implementing audio/video and logic functions of apparatus 10. For example, the processor 20 may comprise a digital signal processor device, a microprocessor device, an analog-to-digital converter, a digital-to-analog converter, and/or the like. Control and signal processing functions of the apparatus 10 may be allocated between these devices according to their respective capabilities. The processor 20 may additionally comprise an internal voice coder (VC) 20a, an internal data modem (DM) 20b, and/or the like. Further, the processor 20 may include functionality to operate one or more software programs, which may be stored in memory. In general, processor 20 and stored software instructions may be configured to cause apparatus 10 to perform actions. For example, processor 20 may be capable of operating a connectivity program, such as a web browser. The connectivity program may allow the apparatus 10 to transmit and receive web content, such as location-based content, according to a protocol, such as wireless application protocol, WAP, hypertext transfer protocol, HTTP, and/or the like.

Apparatus 10 may also comprise a user interface including, for example, an earphone or speaker 24, a ringer 22, a microphone 26, a display 28, a user input interface, and/or the like, which may be operationally coupled to the processor 20. The display 28 may, as noted above, include a touch sensitive display, where a user may touch and/or gesture to make selections, enter values, and/or the like. The processor 20 may also include user interface circuitry configured to control at least some functions of one or more elements of the user interface, such as the speaker 24, the ringer 22, the microphone 26, the display 28, and/or the like. The processor 20 and/or user interface circuitry comprising the processor 20 may be configured to control one or more functions of one or more elements of the user interface through computer program instructions, for example, software and/or firmware, stored on a memory accessible to the processor 20, for example, volatile memory 40, non-volatile memory 42, and/or the like. The apparatus 10 may include a battery for powering various circuits related to the mobile terminal, for example, a circuit to provide mechanical vibration as a detectable output. The user input interface may comprise devices allowing the apparatus 20 to receive data, such as a keypad 30 (which can be a virtual keyboard presented on display 28 or an externally coupled keyboard) and/or other input devices.

As shown in FIG. 6, apparatus 10 may also include one or more mechanisms for sharing and/or obtaining data. For example, the apparatus 10 may include a short-range radio frequency (RF) transceiver and/or interrogator 64, so data may be shared with and/or obtained from electronic devices in accordance with RF techniques. The apparatus 10 may include other short-range transceivers, such as an infrared (IR) transceiver 66, a Bluetooth™ (BT) transceiver 68 operating using Bluetooth™ wireless technology, a wireless universal serial bus (USB) transceiver 70, a Bluetooth™ Low Energy transceiver, a ZigBee transceiver, an ANT transceiver, a cellular device-to-device transceiver, a wireless local area link transceiver, and/or any other short-range radio technology. Apparatus 10 and, in particular, the short-range transceiver may be capable of transmitting data to and/or receiving data from electronic devices within the proximity of the apparatus, such as within 10 meters, for example. The apparatus 10 including the Wi-Fi or wireless local area networking modem may also be capable of transmitting and/or receiving data from electronic devices according to various wireless networking techniques, including 6LoWpan, Wi-Fi, Wi-Fi low power, WLAN techniques such as IEEE 802.11 techniques, IEEE 802.15 techniques, IEEE 802.16 techniques, IEEE 802.15.4, and/or the like.

The apparatus 10 may comprise memory, such as a subscriber identity module (SIM) 38, a removable user identity module (R-UIM), an eUICC, an UICC, and/or the like, which may store information elements related to a mobile subscriber. In addition to the SIM, the apparatus 10 may include other removable and/or fixed memory. The apparatus 10 may include volatile memory 40 and/or non-volatile memory 42. For example, volatile memory 40 may include Random Access Memory (RAM) including dynamic and/or static RAM, on-chip or off-chip cache memory, and/or the like. Non-volatile memory 42, which may be embedded and/or removable, may include, for example, read-only memory, flash memory, magnetic storage devices, for example, hard disks, floppy disk drives, magnetic tape, optical disc drives and/or media, non-volatile random access memory (NVRAM), and/or the like. Like volatile memory 40, non-volatile memory 42 may include a cache area for temporary storage of data. At least part of the volatile and/or non-volatile memory may be embedded in processor 20. The memories may store one or more software programs, instructions, pieces of information, data, and/or the like which may be used by the apparatus for performing operations, such as process processes 200, 300, and/or 400 and/or any other operations/functions disclosed herein. The memories may comprise an identifier, such as an international mobile equipment identification (IMEI) code, capable of uniquely identifying apparatus 10. The memories may comprise an identifier, such as an international mobile equipment identification (IMEI) code, capable of uniquely identifying apparatus 10. In the example embodiment, the processor 20 may be configured using computer code stored at memory 40 and/or 42 to control and/or provide one or more aspects disclosed herein with respect to processes 200, 300, and/or 400 including for example scanning, by a user equipment, for one or more virtual devices that are published and accessing, by the user equipment, a state of the scanned one or more virtual devices.

Some of the embodiments disclosed herein may be implemented in software, hardware, application logic, or a combination of software, hardware, and application logic. The software, application logic, and/or hardware may reside on memory 40, the control apparatus 20, or electronic components, for example. In some example embodiment, the application logic, software or an instruction set is maintained on any one of various conventional computer-readable media. In the context of this document, a “computer-readable medium” may be any non-transitory media that can contain, store, communicate, propagate or transport the instructions for use by or in connection with an instruction execution system, apparatus, or device, such as a computer or data processor circuitry, with examples depicted at FIG. 6, computer-readable medium may comprise a non-transitory computer-readable storage medium that may be any media that can contain or store the instructions for use by or in connection with an instruction execution system, apparatus, or device, such as a computer.

Without in any way limiting the scope, interpretation, or application of the claims appearing below, a technical effect of one or more of the example embodiments disclosed herein is improved integration of physical and virtual. Without in any way limiting the scope, interpretation, or application of the claims appearing below, a technical effect of one or more of the example embodiments disclosed herein is improved user interfaces showing real devices in the virtual world and vice versa.

The subject matter described herein may be embodied in systems, apparatus, methods, and/or articles depending on the desired configuration. For example, the base stations and user equipment (or one or more components therein) and/or the processes described herein can be implemented using one or more of the following: a processor executing program code, an application-specific integrated circuit (ASIC), a digital signal processor (DSP), an embedded processor, a field programmable gate array (FPGA), and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device. These computer programs (also known as programs, software, software applications, applications, components, program code, or code) include machine instructions for a programmable processor, and may be implemented in a high-level procedural and/or object-oriented programming language, and/or in assembly/machine language. As used herein, the term “computer-readable medium” refers to any computer program product, machine-readable medium, computer-readable storage medium, apparatus and/or device (for example, magnetic discs, optical disks, memory, Programmable Logic Devices (PLDs)) used to provide machine instructions and/or data to a programmable processor, including a machine-readable medium that receives machine instructions. Similarly, systems are also described herein that may include a processor and a memory coupled to the processor. The memory may include one or more programs that cause the processor to perform one or more of the operations described herein.

Although a few variations have been described in detail above, other modifications or additions are possible. In particular, further features and/or variations may be provided in addition to those set forth herein. Moreover, the implementations described above may be directed to various combinations and subcombinations of the disclosed features and/or combinations and subcombinations of several further features disclosed above. Other embodiments may be within the scope of the following claims.

If desired, the different functions discussed herein may be performed in a different order and/or concurrently with each other. Furthermore, if desired, one or more of the above-described functions may be optional or may be combined. Although various aspects of some of the embodiments are set out in the independent claims, other aspects of some of the embodiments comprise other combinations of features from the described embodiments and/or the dependent claims with the features of the independent claims, and not solely the combinations explicitly set out in the claims. It is also noted herein that while the above describes example embodiments, these descriptions should not be viewed in a limiting sense. Rather, there are several variations and modifications that may be made without departing from the scope of some of the embodiments as defined in the appended claims. Other embodiments may be within the scope of the following claims. The term “based on” includes “based on at least.” The use of the phase “such as” means “such as for example” unless otherwise indicated.

1. A method comprising:
scanning, by a user equipment, for one or more virtual devices that are published; and
accessing, by the user equipment, a state of the scanned one or more virtual devices; and
establishing connections between one or more virtual nodes representing the scanned one or more virtual devices and one or more real nodes.

2. The method of claim 1, wherein the one or more virtual devices comprise one or more internet of things devices.

3. The method of claims 1, wherein the one or more virtual devices are published by advertising an identifier for each of the one or more virtual devices.

4. The method of claim 3, wherein the identifier includes at least one of an indication that a virtual device is virtual, an identity of a game where the virtual device is located, or an identity of a user associated with the game.

5. The method of claim 4, wherein the identifier for a virtual device includes a same format as another identifier for a real device.

6. The method of claims 1 further comprising:
presenting, by the user equipment, a user interface including one or more icons corresponding to the scanned one or more virtual devices and one or more other icons corresponding to one or more real internet of things devices.

7. The method of claims 1, wherein the one or more virtual devices are published by a gaming device.

8. An apparatus, comprising:
at least one processor; and
at least one memory including computer program code, the at least one memory and the computer program code configured to, with the at least one processor, cause the apparatus to perform at least the following:
scan, by the apparatus, for one or more virtual devices that are published; and
access, by the apparatus, a state of the scanned one or more virtual devices; and
establish connections between one or more virtual nodes representing the scanned one or more virtual devices and one or more real nodes.

9. The apparatus of claim 8, wherein the one or more virtual devices comprise one or more internet of things devices.

10. The apparatus of claims 8, wherein the one or more virtual devices are published by advertising a identifier for each of the one or more virtual devices.

11. The apparatus of claim 10, wherein the identifier includes at least one of an indication that a virtual device is virtual, an identity of a game where the virtual device is located, or an identity of a user associated with the game.

12. The apparatus of claim 11, wherein the identifier for a virtual device includes a same format as another identifier for a real device.

13. The apparatus of claims 8, wherein the apparatus is further configured to at least present a user interface including one or more icons corresponding to the scanned one or more virtual devices and one or more other icons corresponding to one or more real internet of things devices.

14. The apparatus of claims 8, wherein the one or more virtual devices are published by a gaming device.

15. A non-transitory computer readable storage medium including computer program code which when executed by at least one processor causes operations comprising:
scanning, by a user equipment, for one or more virtual devices that are published; and
accessing, by the user equipment, a state of the scanned one or more virtual devices; and
establishing connections between one or more virtual nodes representing the scanned one or more virtual devices and one or more real nodes.

16. An apparatus comprising:
means for scanning for one or more virtual devices that are published; and
means for accessing a state of the scanned one or more virtual devices.

17. The apparatus of claim 16, wherein the one or more virtual devices comprise one or more internet of things devices.

18. The apparatus of claims 16, wherein the one or more virtual devices are published by advertising a identifier for each of the one or more virtual devices.

19. The apparatus of claim 18, wherein the identifier includes at least one of an indication that a virtual device is virtual, an identity of a game where the virtual device is located, or an identity of a user associated with the game.

20. The apparatus of claim 19, wherein the identifier for a virtual device includes a same format as another identifier for a real device.

21. The apparatus of claims 16, wherein the apparatus is further configured to at least present a user interface including one or more icons corresponding to the scanned one or more virtual devices and one or more other icons corresponding to one or more real internet of things devices.

22. The apparatus of claims 16, wherein the one or more virtual devices are published by a gaming device.
